(19) United States
(12) Patent Application Publication
(10) Pub. No.: US 2007/0010295 A1
(43) Pub. Date: Jan. 11, 2007

(54) Power transmission system, apparatus and method with communication

(75) Inventors: Charles E. Greene, Pittsburgh, PA (US); Daniel W. Harrist, Carnegie, PA (US); John G. Shearer, Ligonier, PA (US)

Correspondence Address: Ansel M. Schwartz, Suite 304, 201 N. Craig Street, Pittsburgh, PA, 15213, US

(73) Assignee: FireFly Power Technologies, Inc.

(21) Appl. No.: 11/481,499

(22) Filed: Jul. 6, 2006

Related U.S. Application Data
(60) Provisional application No. 60/697,715, filed on Jul. 8, 2005.

(51) Int. Cl. H04B 1/38; H04M 1/00

(52) U.S. Cl. 455/572

(57) ABSTRACT

A power transmission system with communication having a base station having a wireless power transmitter a wireless data transmission component and a first wireless data reception component. The system includes a remote station having a power harvester for converting the power from the power transmitter into direct current and a power storage component in communication with the power harvester for storing the direct current. Alternatively, the system includes a base station having a wireless power transmitter which transmits power at a frequency at which any sidebands are at or below a desired level, and a first wireless data communication component. Alternatively, the system includes a base station having a wireless power transmitter with an antenna having a range of r≧2D²/λ, where r is the distance between the power transmitter and the remote device, D is the maximum dimension of either the power transmitter antenna or the remote device antenna, and λ is the wavelength of the power frequency; and a first wireless data communication component. A method for transmitting power with communication. An apparatus for power transmission with communication.

### FIELD OF THE INVENTION

The present invention is related to wireless power transmission with communication. More specifically, the present invention is related to wireless power transmission with communication where the transmitted power is at a frequency at which any sideboards are at or below a desired level.

### BACKGROUND OF THE INVENTION

Currently, most RFID systems are passive which means they have a transmitter that is used to provide operational power (electromagnetic field, electric field, or magnetic field) to a receiver (tag) within a specified range. This same transmitter is also used for data communication. This is shown in FIG. 1.

There are several iterations of the system described in FIG. 1. Some of them are illustrated in FIGS. 2 and 3.

In FIG. 2, the data receiver is separated from the transmitter but uses a shared antenna. FIG. 3 shows that the transmitter and receiver may use different antennas. But, in all cases, the power transmitter and data transmitter are incorporated into the same unit. It should be noted that the figures show a single Tag block, however, multiple tags can receive operational power and communicate with the depicted systems.

One system that does not conform to those shown in FIGS. 1-3 was proposed in U.S. Pat. No. 6,289,237, “Apparatus for Energizing a Remote Station and Related Method,” incorporated by reference herein. It describes a system for wireless transmission of power that uses a dedicated transmitter for the operational power in the Industrial, Scientific, and Medical (ISM) bands. The data transceiver is a separate piece of the apparatus. Specifically, FIG. 2 in the referenced patent shows an example of how the base station would be implemented. The base station is used to transmit operational power and data to the remote station. An example of the remote station is shown in FIG. 3 of the referenced patent, which shows a dual band antenna used to receive the operational power and transmit and receive data. The present invention differs from U.S. Pat. No. 6,289,237 in the fact that the proposed remote station is not a passive system meaning it contains power storage and has the ability to operate when the base station is not supplying the operational power. The referenced patent specifically states in column 3, lines 51-56, “One of the advantages of the present invention is that the source of power for the remote station 4 is the base station 2 and, therefore, there is no need for hard wiring or printed circuit physical connections with remote station 4. There is also no need for remote station 4 to carry an electrical storage device such as a battery.”

### BRIEF SUMMARY OF THE INVENTION

The present invention pertains to a power transmission system with communication. The system comprises a base station having a wireless power transmitter which transmits power at a first frequency and a first wireless data communication component which communicates at a second frequency different from the first frequency. The system comprises a remote station having a power harvester for converting the power from the power transmitter into direct current and a power storage component in communication with the power harvester for storing the direct current.

The present invention pertains to a power transmission apparatus with communication. The apparatus comprises a base station having a wireless power transmitter which transmits power at a frequency at which any sidebands are at or below a desired level, and a wireless data communication component.

The present invention pertains to a power transmission apparatus with communication to a remote device having an antenna. The apparatus comprises a base station having a wireless power transmitter with an antenna having a range of r≧2D²/λ, where r is the distance between the power transmitter and the remote device, D is the maximum dimension of either the power transmitter antenna or the remote device antenna, and λ is the wavelength of the power frequency, and a wireless data communication component.

The present invention pertains to a method for transmitting power with communication. The method comprises the steps of transmitting power wirelessly from a power transmitter of a base station. There is the step of transmitting data wirelessly from a first data transmission component of the base station concurrently with the transmission of power from the power transmitter. There is the step of converting the power from the power transmitter into direct current with a power harvester at a remote station. There is the step of storing the DC current in a power storage component in communication with the power harvester.

The present invention pertains to a method for transmitting power with communication. The method comprises the steps of transmitting power wirelessly from a power transmitter of a base station at a frequency at which any side bands are at or below a desired level. There is the step of transmitting data wirelessly from a data transmission component of the base station concurrently with the transmission of power from the power transmitter.

The present invention pertains to a method for transmitting power with communication to a remote device having a power harvester and an antenna. The method comprises the steps of transmitting power wirelessly from a power transmitter of a base station having a wireless power transmitter with an antenna having a range of r≧2D²/λ, where r is the distance between the power transmitter and the remote device, D is the maximum dimension of either the power transmitter antenna with a remote device antenna, and λ is the wavelength of the power frequency. There is the step of transmitting data wirelessly from a data transmission component of the base station concurrently with the transmission of power from the power transmitter.

The present invention pertains to a method for power transmission system with communication. The method comprises the steps of transmitting power wirelessly from a base station. There is the step of converting the power from the power transmitter into direct current with a power harvester of a remote station. There is the step of storing the direct current in a power storage component of the remote station in communication with the power harvester. There is the step of communicating data wirelessly from the remote station with a second data communication component in communication with the power harvester. There is the step of receiving at a data station the data transmitted by the remote station, the data station remote from the base station and the remote station.

The present invention pertains to a power transmission system with communication. The system comprises a base station having a wireless power transmitter, and a first wireless communication component (preferably including a wireless data transmission component and a wireless data reception component communication). The system comprises a remote station having a power harvester for converting the power from the power transmitter into direct current and a power storage component in communication with the power harvester for storing the direct current, the operation of the remote station independent of the operation of the base station.

The present invention pertains to a method for transmitting power with communication. The method comprises the steps of transmitting power wirelessly from a power transmitter of a base station. There is the step of transmitting data wirelessly from a data transmission component of the base station concurrently with the transmission of power from the power transmitter. There is the step of converting the power from the power transmitter into direct current with a power harvester at a remote station independent of the operation of the base station. There is the step of storing the DC current in a power storage component in communication with the power harvester.

The present invention pertains to a power transmission apparatus with communication. The apparatus comprises a base station having a wireless power transmitter which transmits power in pulses. The apparatus comprises a first wireless data communication component.

The present invention pertains to a power transmission system with communication. The system comprises a base station having a wireless power transmitter. The system comprises a remote station having a power harvester for converting the power from the power transmitter into direct current and a power storage component in communication with the power harvester for storing the direct current, a second data communication component in communication with the power harvester communicating data wirelessly, and core device components in communication with the power harvester. The system comprises at least one data station remote from the base station and the remote station which communicates with the data communicated by the second data communications component.

The present invention pertains to a method for transmitting power with communication. The method comprises the steps of transmitting power wirelessly in pulses from a power transmitter of a base station. There is the step of communicating data wirelessly from a first data communication component of the base station.

The present invention pertains to a power transmission apparatus with communication. The system comprises a base station having a wireless power transmitter which transmits power, and a first wireless data transmission component, where the power transmitter and the data transmission component are each optimized for their specific purpose.

The present invention pertains to a method for transmitting power with communication. The method comprises the steps of transmitting power wirelessly from a power transmitter of a base station. There is the step of transmitting data wirelessly from a data transmission component of the base station. There is the step of receiving the data wirelessly at a remote station. There is the step of converting the power from the power transmitter into direct current with a power harvester at the remote station. There is the step of storing the DC current in a power storage component in communication with the power harvester. There is the step of moving the remote station out of range of the power transmitter. There is the step of continuing to receive data wirelessly from the base station at the remote station while the remote station is out of range of the power transmitter. There is the step of returning the remote station into range of the power transmitter.

The present invention pertains to a power transmission system with communication. The system comprises means for wirelessly transmitting power and data. The system comprises means for converting the power from the transmitting means into direct current and receiving the data remote from the transmitting means.

### BRIEF DESCRIPTION OF THE SEVERAL VIEWS OF THE DRAWING

In the accompanying drawings, the preferred embodiment of the invention and preferred methods of practicing the invention are illustrated in which:

FIG. 1 is a block diagram of a current passive RFID system with power and data in the same unit of the prior art.

FIG. 2 is a block diagram of a data receiver separated from the transmitter of the prior art.

FIG. 3 is a block diagram of a data receiver separated from the transmitter using its own antenna of the prior art.

FIG. 4 is a block diagram of a pulsed power method to increase power at device.

FIG. 5 is a block diagram of the system where each part has its own antenna and circuitry.

FIG. 6 is a block diagram of the system where the data portions share an antenna and may be combined.

FIG. 7 is a block diagram of the device which uses one antenna for power, transmission, and reception.

FIG. 8 is a block diagram of a device that has two antennas; one for communication and one for power.

FIG. 9 is a block diagram of a device with antennas dedicated to each function.

FIG. 10 is a block diagram of implementation of the power TX block.

FIG. 11 is a block diagram of implementation of the data TX block.

FIG. 12 is a block diagram of implementation of the data RX block.

FIG. 13 is a block diagram of implementation of the device block using a transceiver and a single antenna.

FIG. 14 is a block diagram of implementation of the device block using a transceiver and separate power and data antennas.

FIG. 15 is a block diagram of implementation of the device block using a data transmitter and data receiver with separate antennas.

FIG. 16 is a graph showing 13.56 MHz ISM band emission limits.

FIG. 17 is a graph showing frequency spectrum of an AM signal.

FIG. 18 is a graph showing amplitude modulated signal superimposed on FCC emission limits with sidebands over emission limit.

FIG. 19 is a graph showing amplitude modulated signal superimposed on FCC emission limits with all frequencies within regulation.

### DETAILED DESCRIPTION OF THE INVENTION

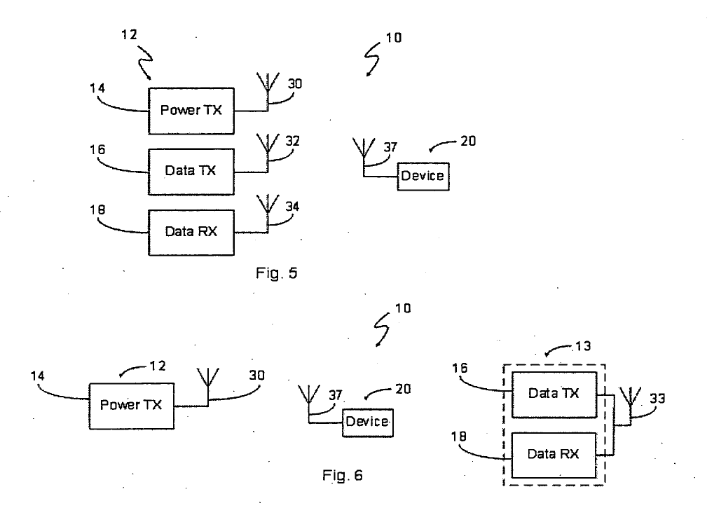

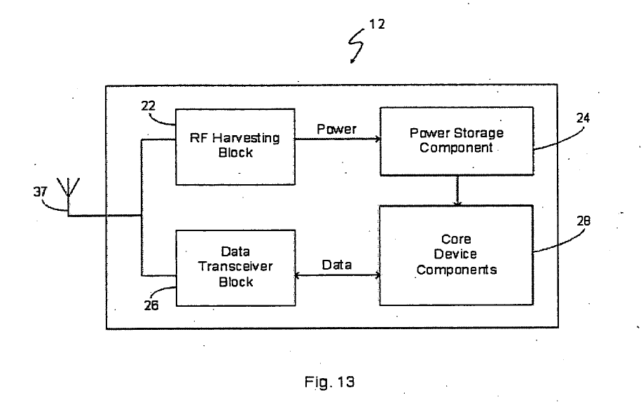

Referring now to the drawings wherein like reference numerals refer to similar or identical parts throughout the several views, and more specifically to FIGS. 5 and 6 thereof, there is shown a power transmission system 10 with communication. The system 10 comprises a base station 12 having a wireless power transmitter 14 which transmits power at a first frequency; and a first wireless data communication component 11 which communicates at a second frequency different from the first frequency. The communication component 11 preferably includes a wireless data transmission component 16 and a wireless data reception component 18. The system 10 comprises a remote station 20 having a power harvester 22 for converting the power from the power transmitter 14 into direct current and a power storage component 24 in communication with the power harvester 22 for storing the direct current, as shown in FIG. 13.

Preferably, the remote station 20 includes a second data communication component in communication with the power harvester 22. Preferably, the second data communication component includes a data transceiver 26 for receiving wireless data and transmitting data wirelessly, and core device components 28 in communication with the power harvester 22. The power transmitter 14 preferably has a power transmission antenna 30, the data transmission component 16 has a data transmission antenna 32 and the data reception component 18 has a data reception antenna 34, as shown in FIG. 5.

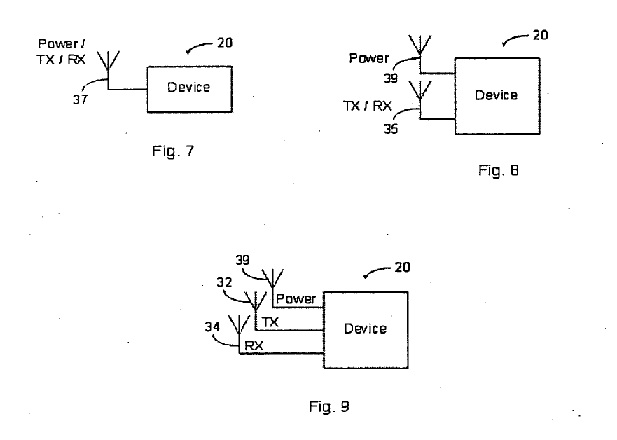

Alternatively, the power transmitter 14 has a power transmission antenna 30 and the data transmission component 16 and the data receiver 44 component are connected to and share a data antenna 33, as shown in FIG. 6. The data transceiver 26 and the power harvester 22 are preferably connected to and share a receiver antenna 37, as shown in FIG. 7.

Alternatively, the data transceiver 26 has a data transceiver antenna 35 and the power harvester 22 has a power reception antenna 39, as shown in FIG. 8. The transceiver preferably has a data transmitter 48 having a data transmission antenna 32 and a data receiver 44 having a data reception antenna 34, and the power harvester 22 has a power reception antenna 39, as shown in FIG. 9.

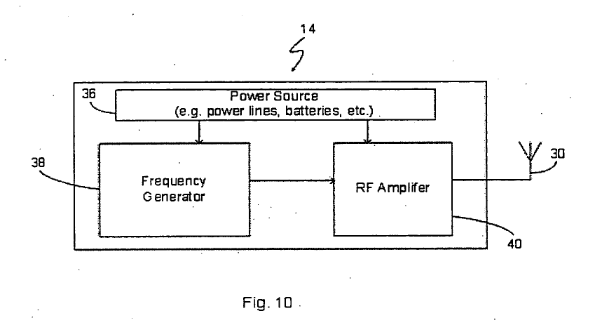

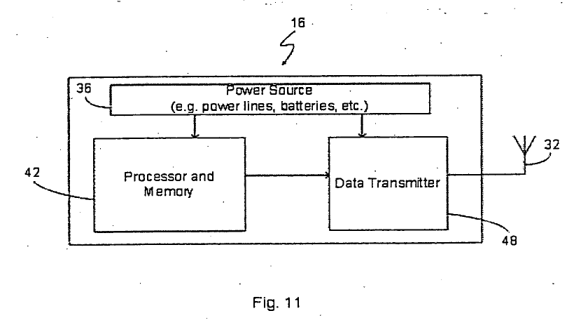

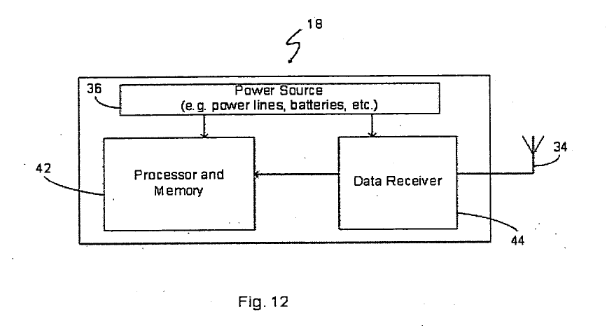

Preferably, the power transmitter 14 includes a power source 36, a frequency generator 38 connected to the power source 36 and an RF amplifier 40 connected to the power source 36 and the power transmission antenna 30, as shown in FIG. 10. The data transmission component 16 preferably includes a power source 36, a processor and memory 42 connected to the power source 36 and a data transmitter 48 connected to the data transmission antenna 32, as shown in FIG. 11. Preferably, the data reception component 18 includes a power source 36, and processor and memory 42 connected to the power source 36 and a data receiver 44 connected to the data reception antenna 34, as shown in FIG. 12.

The present invention pertains to a power transmission apparatus 21 with communication. The apparatus 21 comprises a base station 12 having a wireless power transmitter 14 which transmits power at a frequency at which any sidebands are at or below a desired level, and a first wireless data communication component 11. The communication component 11 preferably includes a wireless data transmission component 16; and a wireless data reception component 18. Ideally, the desired level of the sidebands is zero, where zero is the desired level.

The present invention pertains to a power transmission system 10 with communication to a remote device having an antenna. The system 10 comprises a base station 12 having a wireless power transmitter 14 with an antenna having a range of r≧2D²/λ, where r is the distance between the power transmitter 14 and the remote device, D is the maximum dimension of either the power transmitter antenna or the remote device antenna, and λ is the wavelength of the power frequency, and a wireless data communication component 11. The communication component 11 preferably includes a wireless data transmission component 16; and a wireless data reception component 18.

The present invention pertains to a method for transmitting power with communication. The method comprises the steps of transmitting power wirelessly from a power transmitter 14 of a base station 12. There is the step of transmitting data wirelessly from a data transmission component 16 of the base station 12 concurrently with the transmission of power from the power transmitter 14. There is the step of receiving data wirelessly from a wireless data reception component 18 of the base station 12. There is the step of converting the power from the power transmitter 14 into direct current with a power harvester 22 at a remote station 20. There is the step of storing the DC current in a power storage component 24 in communication with the power harvester 22. Preferably, the power transmitting step includes the step of transmitting power wirelessly from the power transmitter at a first frequency, and the data transmitting step includes the step of transmitting data wirelessly from the data transmission component at a second frequency different from the first frequency.

The present invention pertains to a method for transmitting power with communication. The method comprises the steps of transmitting power wirelessly from a power transmitter 14 of a base station 12 at a frequency at which any side bands are at or below a desired level. There is the step of transmitting data wirelessly from a data transmission component 16 of the base station 12 concurrently with the transmission of power from the power transmitter 14.

Preferably, there is the step of receiving data wirelessly from a wireless data reception component 18 of the base station 12. There is preferably the step of converting the power from the power transmitter 14 into direct current with a power harvester 22 in a remote station 20. Preferably, there is the step of storing the DC current in a power storage component 24 in communication with the power harvester 22.

The present invention pertains to a method for transmitting power with communication to a remote device having a power harvester 22 and an antenna. The method comprises the steps of transmitting power wirelessly from a power transmitter 14 of a base station 12 having a wireless power transmitter 14 with an antenna having a range of r≧2D²/λ, where r is the distance between the power transmitter 14 and the remote device, D is the maximum dimension of either the power transmission antenna 30 with a remote device antenna, and λ is the wavelength of the power frequency. There is the step of transmitting data wirelessly from a data transmission component 16 of the base station 12 concurrently with the transmission of power from the power transmitter 14.

Preferably, there is the step of receiving data wirelessly by a wireless data reception component 18 of the base station 12.

The present invention pertains to a power transmission system 10 with communication. The system comprises a base station 12 having a wireless power transmitter 14. The system comprises a remote station 20 having a power harvester 22 for converting the power from the power transmitter 14 into direct current and a power storage component 24 in communication with the power harvester 22 for storing the direct current, a second data communication component in communication with the power harvester 22 communicating data wirelessly, and core device components 28 in communication with the power harvester 22. The system comprises at least one data station remote from the base station 12 and the remote station 20 which communicates (preferably receives) the data communicated by (preferably transmitted) the second data communication component.

The data can include audio and video signals. The base station 12 can include a wireless data transmission component 16. The base station 12 can include a wireless data reception component 18. The remote station 20 can include a wireless data reception component 18. The remote station 20 can include a keyboard. The data station can include a computer. Alternatively, the remote station 20 can include a sensor.

The present invention pertains to a method for power transmission system 10 with communication. The method comprises the steps of transmitting power wirelessly from a base station 12. There is the step of converting the power from the power transmitter 14 into direct current with a power harvester 22 of a remote station 20. There is the step of storing the direct current in a power storage component 24 of the remote station 20 in communication with the power harvester 22. There is the step of communicating data wirelessly from the remote station 20 with a second data communication component in communication with the power harvester 22. There is the step of receiving at a data station the data transmitted by the remote station 20, the data station remote from the base station 12 and the remote station 20.

The present invention pertains to a power transmission system 10 with communication. The system comprises a base station 12 having a wireless power transmitter 14, and a first wireless communication component (preferably including a wireless data transmission component 16 and a wireless data reception component 18 communication). The system comprises a remote station 20 having a power harvester 22 for converting the power from the power transmitter 14 into direct current and a power storage component 24 in communication with the power harvester 22 for storing the direct current, the operation of the remote station 20 independent of the operation of the base station 12. Preferably, the remote station 20 does not provide any feedback regarding its operation to the base station 12.

The present invention pertains to a method for transmitting power with communication. The method comprises the steps of transmitting power wirelessly from a power transmitter 14 of a base station 12. There is the step of transmitting data wirelessly from a data transmission component 16 of the base station 12 concurrently with the transmission of power from the power transmitter 14. There is the step of converting the power from the power transmitter 14 into direct current with a power harvester 22 at a remote station 20 independent of the operation of the base station 12. There is the step of storing the DC current in a power storage component 24 in communication with the power harvester 22.

The present invention pertains to a power transmission apparatus 21 with communication. The apparatus 21 comprises a base station 12 having a wireless power transmitter 14 which transmits power in pulses. The apparatus 21 comprises a wireless data transmission component 16.

The first data communication component can transmit data between the pulses. The first data communication component preferably transmits data at a maximum baud rate. The apparatus 21 can include a power transmission antenna 30 in communication with the power transmitter 14 through which the pulses are transmitted, and a data communication antenna in communication with the first data communication component though which the data is transmitted.

The present invention pertains to a method for transmitting power with communication. The method comprises the steps of transmitting power wirelessly in pulses from a power transmitter 14 of a base station 12. There is the step of communicating data wirelessly from a first data communication component of the base station 12.

The present invention pertains to a power transmission apparatus 21 with communication. The system comprises a base station 12 having a wireless power transmitter 14 which transmits power, and a wireless data transmission component 16, where the power transmitter 14 and the data transmission component 16 are each optimized for their specific purpose.

The present invention pertains to a method for transmitting power with communication. The method comprises the steps of transmitting power wirelessly from a power transmitter 14 of a base station 12. There is the step of transmitting data wirelessly from a data transmission component 16 of the base station 12. There is the step of receiving the data wirelessly at a remote station 20. There is the step of converting the power from the power transmitter 14 into direct current with a power harvester 22 at the remote station 20. There is the step of storing the DC current in a power storage component 24 in communication with the power harvester 22. There is the step of moving the remote station 20 out of range of the power transmitter 14. There is the step of continuing to receive data wirelessly from the base station 12 at the remote station 20 while the remote station 20 is out of range of the power transmitter 14. There is the step of returning the remote station 20 into range of the power transmitter 14.

The present invention pertains to a power transmission system 10 with communication. The system comprises means for wirelessly transmitting power and data. The system comprises means for converting the power from the transmitting means into direct current and receiving the data remote from the transmitting means. The transmitting means can include a base station 12. The means for converting power and receiving data can include a remote station 20.

In the operation of the invention, the system 10 separates the communication and the power components into two transmitting units. The first transmitter is responsible for providing operational power to the tag(s) while the second is used solely for data communication purposes. As a result of this separation, the apparatus receiving operational power from the power transmitter 14 may no longer be an RFID tag. For this reason, the apparatus formerly termed a tag will now be referred to as a device and will contain a power storage component 24 such as, but not limited to, a capacitor, a battery, or other power storage component. It should be noted that the operational power transmitter 14 and the data communication transmitter/receiver are both used in conjunction with the device. More specifically, the Power TX block is used to provide operational power to the device. The Data TX block is used to send data to the device while the Data RX block is used to receive data from the device. The Power TX block, Data TX block, and Data RX block may or may not be in the same housing depending on the most advantageous configuration.

The system 10 eliminates the need for a wired connection in order to transfer charge. The charge is transferred in the form of electromagnetic waves or RF energy. This invention should not be confused with power transfer by inductive coupling, which requires the device to be relatively close to the power transmission source. The present invention was designed to operate in the far-field region but will inherently receive power in the near-field (inductive) region as well as the far-field region. This means the device can receive power at distances greater than those obtained by transferring charge by inductive means. The far-field region is defined as r≧2D²/λ where r is the distance between the operational power transmitter 14 and the device, D is the maximum dimension of either the operational power transmission antenna 30 or the device antenna, and λ is the wavelength of the operational power frequency. As an example, at 915 MHz the wavelength is 0.328 meters. If a half wave dipole is used for transmission and reception of operational power, the far-field region distance, r, would be defined as r≧2D²/λ where D is λ/2 for a half wave dipole antenna. The far-field and near-field boundary is then defined as r=2D²/λ=2(λ/2)²/λ=2λ/4=λ/2. Therefore, the far-field region for the given example is 0.164 meters.

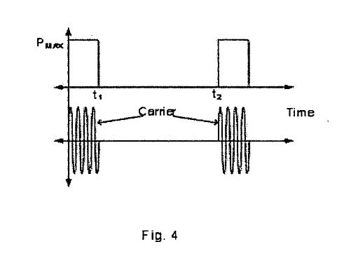

The separation of the two transmitting units allows each transmitter to be optimized for its specific purpose. As an example, it was proposed in U.S. Provisional Patent Application 60/656,165, “Pulse Transmission Method,” incorporated by reference herein, that using a pulsing profile increases the amount of operational power available at the receiver due to an increase in rectifier efficiency. The use of a pulsing profile limits the bandwidth of the communication portion of the device. This can be seen by examining FIG. 4.

If the data communication were built into the same transmitter used for powering the device, there would be no carrier for the data during the OFF periods (t₁ to t₂) of the waveform. The result would be a decrease in the maximum baud rate, which becomes important when there are numerous devices or large amounts of data. The present invention does not suffer from these issues. The transmitter can use a more advantageous method for operational power transfer, such as pulsing, while the communication transmitter can maintain the maximum baud rate possible. The following figures show how the system 10 would be implemented. FIG. 5 is a system 10 that separates the powering, data transmitting, and data receiving parts with each having its own antenna and circuitry. In FIG. 6, the data transmitting and receiving units use the same antenna and may be combined into a single block. However, the powering transmitter is still separated from the communicating apparatus. It should be noted that the Power TX, Data TX, and Data RX blocks may each be controlled by an integrated microprocessor or by a single microprocessor in communication with the necessary blocks. It may also be possible to control the Power RX block with a first microprocessor and the Data TX and Data RX blocks with a second microprocessor. The two microprocessors may or may not be in communication with each other. The Power TX, Data TX, and Data RX blocks may also each have or share memory and/or other controlling circuitry.

One system that bares resemblance to the systems shown in FIGS. 5 and 6 was proposed in U.S. Pat. No. 6,289,237, “Apparatus for Energizing a Remote Station and Related Method,” incorporated by reference herein. It describes a system for wireless transmission of power that uses a dedicated transmitter for the operational power in the Industrial, Scientific, and Medical (ISM) bands. The data transceiver 26 is a separate piece of the apparatus. Specifically, FIG. 2 in the referenced patent shows an example of how the base station 12 would be implemented. The base station 12 is used to transmit operational power and data to the remote station. An example of the remote station is shown in FIG. 3 of the referenced patent, which shows a dual band antenna used to receive the operational power and transmit and receive data. The present invention differs from U.S. Pat. No. 6,289,237 in the fact that the proposed device (remote station) is not a passive system meaning it contains power storage and has the ability to operate when the base station 12 is not supplying the operational power. The referenced patent specifically states in column 3, lines 51-56, “One of the advantages of the present invention is that the source of power for the remote station 4 is the base station 2 and, therefore, there is no need for hard wiring or printed circuit physical connections with remote station 4. There is also no need for remote station 4 to carry an electrical storage device such as a battery.” The present invention includes a power storage component in the device to allow operation at distances greater than the operational power transmitter 14 can supply the operational power to the device. Because the communication distance will generally be greater than the distance at which the device can receive operational power, the addition of a power storage component 24 allows the device to continue operation and communication while not receiving power from the operational power transmitter 14. In the rare case that the device is beyond the range of operational power and communication, the addition of the power storage component 24 allows operation to continue until the device is able to return to the communication and/or operational power range. This would require that the device contain a processor such as, but not limited to, a microcontroller or a central processor unit, and/or memory.

The devices shown in FIGS. 5 and 6 may take on many different forms. Some of these are shown in FIGS. 7-9. It should be noted that the figures show a single Device block, however, multiple devices can receive operational power and communicate with the depicted systems.

FIG. 7 is similar to an RFID tag, which uses the same antenna to receive incoming operational power and for data communications. FIG. 8 is a device that has separated the operational power and data communication parts. FIG. 9 has a separate antenna for receiving operational power, receiving data, and transmitting data. All of these devices can be used as part of the present invention and will contain a power storage component 24 such as, but not limited to, a capacitor, a battery, or other power storage component 24.

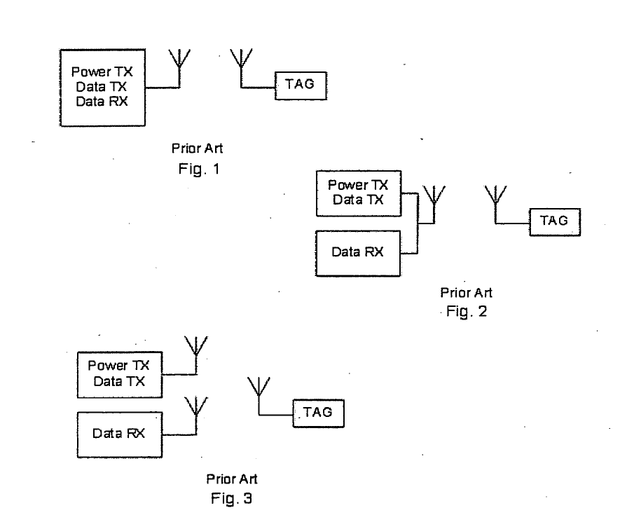

The blocks described in FIGS. 1-9 have been well defined in the prior art. However, the block configurations of the present invention, FIGS. 5-6, are unique and offer a valuable solution to a number of problems such as operational power and data communication optimization and regulatory compliance. Regulatory compliance may include but is not limited to government regulations, industrial standards, and health and safety guidelines. The regulations, standards, and guidelines may be mandated or recommended by groups such as but not limited to the FCC, other government bodies, IEEE, ANSI, IEC, ISO, or other industrial organizations.

The blocks shown can be implemented with various components and configurations. FIG. 10 shows a simple example of how the Power TX block can be implemented. This configuration along with numerous others is shown in U.S. Provisional Patent Application 60/656,165, “Pulse Transmission Method,” incorporated by reference herein. The Data TX and Data RX blocks can be implemented as shown in FIGS. 11 and 12, respectively.

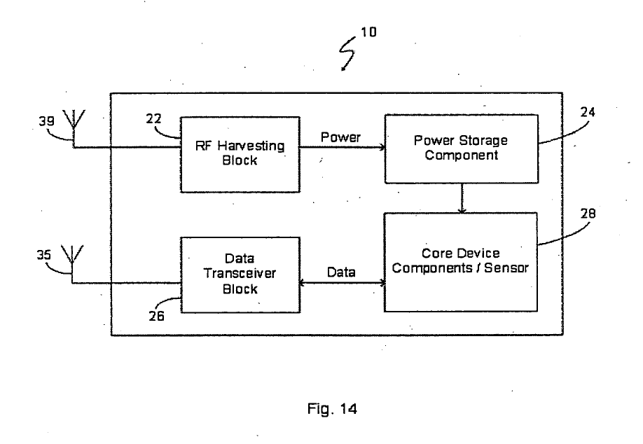

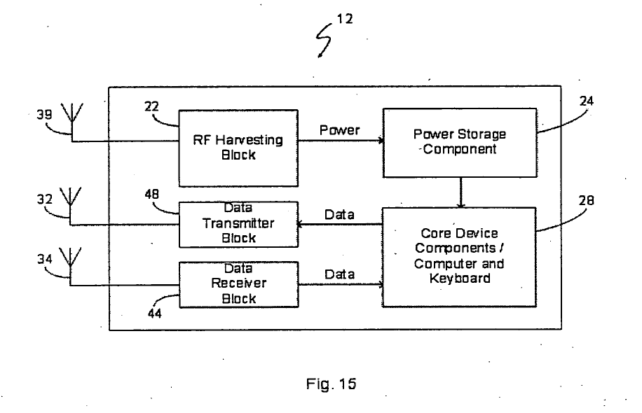

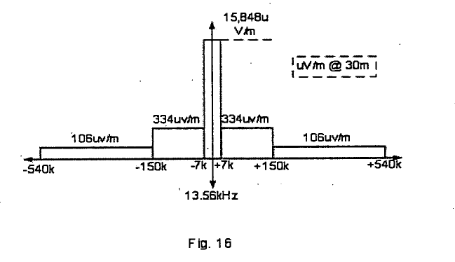

The device block can take many different forms. FIGS. 13-15 illustrate some of the examples of how the device can be implemented. U.S. Provisional Patent Application 60/688,587, “Powering Devices Using RF Energy Harvesting,” incorporated by reference herein, gives a detailed list of devices and configurations that can be used to implement the device block. The device block in FIG. 13 uses a single antenna, which means the RF harvesting block and the data transceiver 26 block must share the antenna for operational power transmission and for data communication. The present invention uses one frequency (channel) for operational power transmission and a separate frequency(s) (channel(s)) for data communication. This means the antenna would need to be a multi-band antenna or would have to have a broad enough band to incorporate the operational power transmission frequency and data transmission frequency(s). In FIG. 13, the data transceiver 26 block must be able to see data captured by the antenna without affecting the RF harvesting block. This can be done in numerous ways. One way would be, but is not limited to, tuning the data transceiver 26 block to the data transmission frequency(s) while ensuring the data transceiver 26 block has a high impedance relative to the RF harvesting block at the operational power transmission frequency. FIGS. 14 and 15 are more straightforward to implement because the operational power transmission frequency and data transmission frequency have been confined to separate antennas, which avoids interference between the blocks. The core device components 28 block may contain, but is not limited to, a microprocessor, microcontroller, memory, and/or other electronic components and sensors. It should be noted that the present invention differs from U.S. Pat. No. 6,289,237 in the fact that the present device (remote station) is not a passive system, meaning it contains power storage and has the ability to operate when the operational power transmitter 14 (base station) is not supplying the operational power.

A functional example of the invention described in this document is a modified wireless keyboard. The unmodified keyboard contained two AA batteries, which were used to run the logic and transmitter to send data about the keystrokes to a receiver connected to a computer. The keyboard was modified to include an additional antenna that was used for receiving operational power. The operational power was transmitted from a base station 12 that was separate from the data-receiving unit and was stored in large capacitor. In this case, the powering and communicating parts of the systems are separate. This is a simplified version of the invention described because it does not send any data to the device. However, if data had to be sent to the keyboard, it would be transmitted from the data base station 12 connected to the computer and not from the powering antenna. Given this example, it should be noted that the present invention may be implemented with one-way communication rather than the two-way communication depicted in the figures. In either case, the powering and communicating portions of the system are separate.

The present invention may also help the device meet certain regulatory specifications. An example of this can be seen by examining the 13.56 MHz ISM band. The FCC emission limits are shown in FIG. 16.

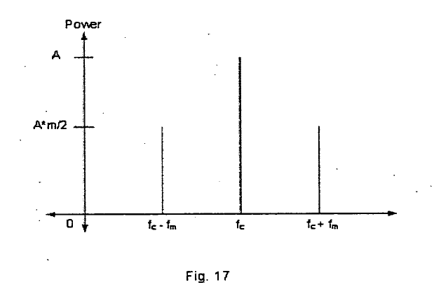

The powering signal for an RFID tag in this band would be transmitted at 13.56 MHz because it is the center of the band with the highest emission limit. To add data to the 13.56 MHz carrier, the carrier frequency is modulated in amplitude or frequency. The modulation produces sideband frequencies in the spectrum of the signal around the carrier. The frequency spectrum for an Amplitude Modulated (AM) signal can be seen in FIG. 17.

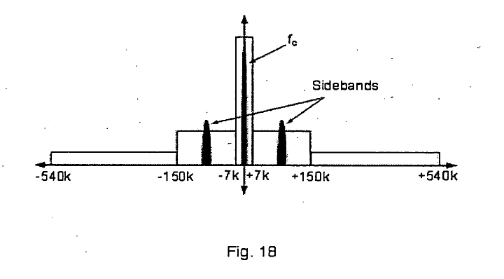

The sideband frequencies (f_{c}−fₘ and f_{c}+fₘ) are spaced above and below the carrier (f_{c}) by the modulation frequency (fₘ). The magnitude of the sideband frequencies (A*m/2) is determined by the modulation factor (m). The modulation factor varies from 0 to 1 where zero corresponds to no modulation and one refers to one hundred percent modulation. The larger the modulation factor the easier it is to detect the data, however, the sideband frequencies grow in magnitude. If an amplitude modulated signal is superimposed on the FCC limit for 13.56 MHz, it can be seen that the level of the sidebands will most likely limit the amount of power in the carrier. This can be seen in FIG. 18.

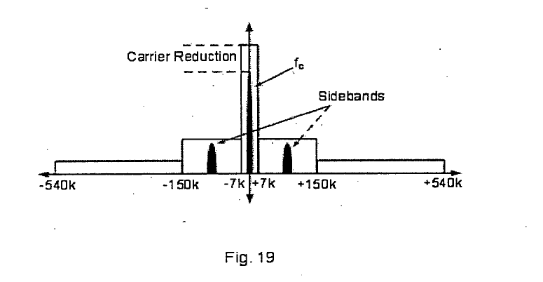

In order to meet the regulations, the power of the transmitter must be reduced to decrease the sidebands levels. This is shown in FIG. 19.

Because the carrier is used to power the device, the range at which the device will work is reduced when the power level is reduced in order to comply with FCC regulations. The present invention allows the power in the carrier to be maximized by removing the modulation from the signal. The data is transmitted and received to and from the device in a separate band to eliminate regulation failures caused by the sidebands. The increase in carrier power means that the device is able to receive operational power at larger distances from the interrogating transmitter.

Although the invention has been described in detail in the foregoing embodiments for the purpose of illustration, it is to be understood that such detail is solely for that purpose and that variations can be made therein by those skilled in the art without departing from the spirit and scope of the invention except as it may be described by the following claims.

1. A power transmission system with communication comprising:
a base station having a wireless power transmitter which transmits power at a first frequency, and a first wireless data communication component which communicates at a second frequency different from the first frequency; and
a remote station having a power harvester for converting the power from the power transmitter into direct current and a power storage component in communication with the power harvester for storing the direct current.

2. A system as described in claim 1 wherein the remote station includes a second wireless data communication component in communication with the power harvester for communicating wirelessly, and core device components in communication with the power harvester.

3. A system as described in claim 2 wherein the power transmitter includes a power source, a frequency generator connected to the power source and an RF amplifier connected to the power source and a power transmission antenna.

4. A system as described in claim 3 wherein the first data communication component includes a data transmission component and a data reception component.

5. A system as described in claim 4 wherein the power transmitter has a power transmission antenna, the data transmission component has the data transmission antenna and the data reception component has a data reception antenna.

6. A system as described in claim 4 wherein the power transmitter has the power transmission antenna and the data transmission component and the data reception component are connected to and share a data antenna.

7. A system as described in claim 5 wherein the data transmission component includes a power source, a processor and memory connected to the power source and a data transmitter connected to the data transmission antenna.

8. A system as described in claim 7 wherein the data reception component includes a power source, and processor and memory connected to the power source and a data receiver connected to the data reception antenna.

9. A system as described in claim 8 wherein the second wireless data communication component includes a data transceiver in communication with the power harvester for receiving wireless data and transmitting data wirelessly.

10. A system as described in claim 9 wherein the data transceiver and the power harvester are connected to and share a receiver antenna.

11. A system as described in claim 9 wherein the data transceiver has a data transceiver antenna and the power harvester has a power reception antenna.

12. A system as described in claim 9 wherein the transceiver has a data transmitter having a data transmission antenna and a data receiver having a data reception antenna, and the power harvester has a power reception antenna.

13. A power transmission apparatus with communication comprising:
a base station having a wireless power transmitter which transmits power at a frequency at which any sidebands are at or below a desired level, and a first wireless data communication component.

14. A power transmission apparatus with communication to a remote device having an antenna comprising:
a base station having a wireless power transmitter with an antenna having a range of r≧2D²/λ, where r is the distance between the power transmitter and the remote device, D is the maximum dimension of either the power transmitter antenna or the remote device antenna, and λ is the wavelength of the power frequency; and a first wireless data communication component.

15. A method for transmitting power with communication comprising the steps of:
transmitting power wirelessly from a power transmitter of a base station;
transmitting data wirelessly from a data transmission component of the base station concurrently with the transmission of power from the power transmitter;
converting the power from the power transmitter into direct current with a power harvester at a remote station; and
storing the DC current in a power storage component in communication with the power harvester.

16. A method as described in claim 15 wherein the power transmitting step includes the step of transmitting power wirelessly from the power transmitter at a first frequency, and the data transmitting step includes the step of transmitting data wirelessly from the data transmission component at a second frequency different from the first frequency.

17. A method for transmitting power with communication comprising the steps of:
transmitting power wirelessly from a power transmitter of a base station at a frequency at which any side bands are at or below a desired level; and
transmitting data wirelessly from a data transmission component of the base station concurrently with the transmission of power from the power transmitter.

18. A method as described in claim 17 including the step of receiving data wirelessly by a wireless data reception component of the base station.

19. A method as described in claim 18 including the step of converting the power from the power transmitter into direct current with a power harvester in a remote station.

20. A method as described in claim 19 including the step of storing the DC current in a power storage component in communication with the power harvester.

21. A method for transmitting power with communication to a remote device having a power harvester and an antenna comprising the steps of:
transmitting power wirelessly from a power transmitter of a base station having a wireless power transmitter with an antenna having a range of r≧2D²/λ, where r is the distance between the power transmitter and the remote device, D is the maximum dimension of either the power transmitter antenna with a remote device antenna, and λ is the wavelength of the power frequency; and
transmitting data wirelessly from a data transmission component of the base station concurrently with the transmission of power from the power transmitter.

22. A method as described in claim 21 including the step of receiving data wirelessly by a wireless data reception component of the base station.

23. A power transmission system with communication comprising:
a base station having a wireless power transmitter;
a remote station having a power harvester for converting the power from the power transmitter into direct current and a power storage component in communication with the power harvester for storing the direct current, a second data communication component in communication with the power harvester communicating data wirelessly, and core device components in communication with the power harvester; and
at least one data station remote from the base station and the remote station, which communicates the data with the second data communication component.

24. A system as described in claim 23 wherein the data includes audio and video signals.

25. A system as described in claim 24 wherein the base station includes a wireless data transmission component.

26. A system as described in claim 25 wherein the base station includes a wireless data reception component.

27. A system as described in claim 23 wherein the remote station includes a wireless data reception component.

28. A system as described in claim 27 wherein the remote station includes a keyboard.

29. A system as described in claim 28 wherein the data station in communication with a computer.

30. A system as described in claim 23 wherein the remote station includes a sensor.

31. A method for power transmission system with communication comprising the steps of:
transmitting power wirelessly from a base station;
converting the power from the power transmitter into direct current with a power harvester of a remote station;
storing the direct current in a power storage component of the remote station in communication with the power harvester;
transmitting data wirelessly from the remote station in communication with the power harvester; and
receiving at a data station the data transmitted by the remote station, the data station remote from the base station and the remote station.

32. A power transmission system with communication comprising:
a base station having a wireless power transmitter, and a first wireless data communication component,
a remote station having a power harvester for converting the power from the power transmitter into direct current and a power storage component in communication with the power harvester for storing the direct current, the operation of the remote station independent of the operation of the base station.

33. A system as described in claim 32 wherein the remote station does not provide any feedback regarding its operation to the base station.

34. A method for transmitting power with communication comprising the steps of:
transmitting power wirelessly from a power transmitter of a base station;
transmitting data wirelessly from a first data transmission component of the base station concurrently with the transmission of power from the power transmitter;
converting the power from the power transmitter into direct current with a power harvester at a remote station independent of the operation of the base station; and
storing the DC current in a power storage component in communication with the power harvester.

35. A power transmission apparatus with communication comprising:
a base station having a wireless power transmitter which transmits power in pulses, and a first wireless data communication component.

36. An apparatus as described in claim 35 wherein the first data communication component transmits data between the pulses.

37. An apparatus as described in claim 35 wherein the first data communication component transmits data at a maximum baud rate.

38. An apparatus as described in claim 37 including a power transmission antenna in communication with the power transmitter through which the pulses are transmitted, and a data communication antenna in communication with the first data communication component through which the data is communicated.

39. A method for transmitting power with communication comprising the steps of:
transmitting power wirelessly in pulses from a power transmitter of a base station; and
communicating data wirelessly from a first data communication component of the base station.

40. A power transmission apparatus with communication comprising:
a base station having a wireless power transmitter which transmits power, and a wireless data transmission component, where the power transmitter and the data transmission component are each optimized for their specific purpose.

41. A method for transmitting power with communication comprising the steps of:
transmitting power wirelessly from a power transmitter of a base station;
transmitting data wirelessly from a data transmission component of the base station;
receiving the data wirelessly at a remote station;
converting the power from the power transmitter into direct current with a power harvester at the remote station;
storing the DC current in a power storage component in communication with the power harvester;
moving the remote station out of range of the power transmitter;
continuing to receive data wirelessly from the base station at the remote station while the remote station is out of range of the power transmitter; and
returning the remote station into range of the power transmitter.

42. A power transmission system with communication comprising:
means for wirelessly transmitting power and data; and
means for converting the power from the transmitting means into direct current and receiving the data remote from the transmitting means.
